(19) United States
(12) Patent Application Publication
(10) Pub. No.: US 2025/0078194 A1
(43) Pub. Date: Mar. 6, 2025

(54) Never Walk Alone Safety App

(71) Applicant: Pamela Joy Garber, Boca Raton, FL (US)

(72) Inventor: Pamela Joy Garber, Boca Raton, FL (US)

(21) Appl. No.: 18/458,617

(22) Filed: Aug. 30, 2023

(51) Int. Cl. G06Q 50/26; H04L 67/306

(52) U.S. Cl. CPC G06Q 50/265; H04L 67/306

(57) ABSTRACT

The Never Walk Alone Safety App menu includes walking companionship, coordinated like a rideshare. Subscribers are organizations, corporations, schools, places of worship, gyms, apartments, co-ops. Subscribers can mute a user within their organization. The app receives arrest notifications from the state database and mutes a user upon arrest notification. Subscribers can decide to use their safety app subscription in a targeted capacity, like an intranet where users within the organization can have limited access among themselves, so faculty would only interact with faculty and students only with students. For example, company PJG, LLC can allow its users to access and interface with users from other subscribing organizations with no exceptions, or can limit its user's use to within the company, but allow multi-organization interaction for walking only, or for another menu item.

### BACKGROUND

The present invention is in the classification system of It relates to novel adaptations and merging of communication technology and data monitoring for app users.

The use of social media is pervasive. Unfortunately, random criminal activity has also been on the rise. Individuals involved in activities by themselves are often the victim of such unpredictable crime while walking or driving. Individuals engaged in travel by themselves would generally benefit by having accompaniment during such travel. It is well known that walking, running, or other outdoor activities in small groups helps avoid the occurrence of crime. However, it is often inconvenient to locate a companion for such activity.

Websites and mobile applications have also been developed or proposed but none of them address this situation specifically. For instance, a message posted by an individual about wanting a jogging partner is sent to everyone accessing that site or application. A response from an interested individual is also sent to the entire group. There may be access limitations imposed by the application, but it is not particularly targeted towards interested individuals. There is a need to build an electronic message board system that allows free exchange of posts about activity between interested users without necessarily involving others who are not actually interested.

For example, U.S. Patent Pub. No. 2020/0396193 to Mayers discloses an electronic message board system and method for matching and connecting users with common interests to jointly engage in a shared activity. Users are associated with user characteristics such as interests and activities. Users' characteristics are matched against activity characteristics and a notification is sent to user to identify and connect other users having matching characteristics. The user is then allowed to respond to the notification by communicating an intent to join the common activity.

U.S. Patent Pub. No. 2016/0379174 to Yust discloses a system and method for facilitating dog owners to meet and coordinate dog walking activities. The system collects profile information from a plurality of users, receives route and time information from a first user describing a planned dog walking time and path that user intends to follow, and allows other users to coordinate their dog walk with the first user. The system allows a user who is out walking his or her pet, or who is preparing to head out on a walk with his or her pet, to log into a network application using an electronic device, input dog walk path and time information, provides a cultivated list of other pet owners and their pets who frequently walk in the same neighborhood as the user, and facilitates the creation of connections, or friend relationships, between users and their pets who agree to be so connected for jointly walking their dogs along the desired path at the desired time.

U.S. Patent Pub. No. 2016/0261985 to Surve discloses a mobile application phone for allow a user to select an interest in performing a social networking or other activity from a list of available activities displayed by the application, enabling the identification and contact of other users that are interested in performing the same activity during the same time period, and enabling communication between such users via an integrated chat messaging system. Searches for identifying other users may be filtered by various selection criteria including age, gender and geographic distance.

Australian Patent Application. No. AU 2018102062 A4 to Joyner discloses a mobile application that allows a registered member to be accompanied from a first location to a second location by walking or other means, via an electronically recorded agreement. A registered user seeking accompaniment inputs their desired passage from Point A to Point B a specified distance. The offering person can accept by taping an “I accept” button, which is then sent back to the user who then finalizes the request by tapping “good to go.” The app relies on user feedback and discloses the use of an initial criminal record to screen users.

Korean Pat. Application. No. KR20170136236A to Ho et al. discloses a route safety guard service using a social network. The disclosed service receives route information from a first user and matching the first user to one or more other users to remotely monitor the location of the first registered user to ensure that the first user is safely along the input and/or has reached the destination. However, the prior art fails to provide adequate security. Although the prior art mentions the use of arrest information to screen potential users, it does not provide enabling disclosure of for the implementation of such a concept and does not ensure continued security. Accordingly, there is a need for methods and systems for providing systems and methods accessible to users by stationary or mobile devices that serve as a conduit for increased safety by increasing fellowship for users and providing vetted membership that is continually or periodically updated to ensure that users are not security threats.

U.S. Pat. No. 9,671,239 B2 Nextdoor.com can mute a profile due to complaints about a user's post or if the user posts something out of Nextdoor.com boundaries. There is no arrest notification feature or other organization involved on a user's behalf.

A user on Nextdoor.com can mute another person's communication and can cancel his profile. There are no structural aspects for group membership-users are only individual based.

### BRIEF SUMMARY

Merged aspects of random street assaults, isolation, and longer work hours complicate safety. Routine obligations are more stressful as random street attacks escalate. The problem of walking from a starting point to a destination point safely makes the use of a safety app timely. The quality of an app is dependent upon the safety, security, and intentions of its users.

Recently, safety apps have been made available on android and I-Phones. Safety apps offer advantages that include providing a documented, retrievable route as the user is walking, easy access for contacting emergency help, sending a notification to specified others in an emergency, video documentation in case of an attack or threat, potential pairing for various activities and finally, data monitoring. However, the vulnerable factors that increase the likelihood of an assault are not addressed.

Community orients apps, including Nextdoor.com and Meetup.com provide a conduit for linking likeminded people with shared goals. The resulting awareness of neighborhood risks may lead to a user changing behaviors. Regarding assault prevention, the user who is unable to alter walking or communing behaviors is not significantly helped. This is especially the case when the user must walk or commute on an immediate or unpredictable basis.

Software screening systems monitor arrests, and other changes to one's records. The timeline for accessing this information can take over forty-eight hours or more, there is often a lack of transmission of this information between the reporting agency and the individuals who need the information the most.

The present invention comprises a novel subscription only safety app in which the subscribers are various organizations who monitor their members, employees, students, faculty, and congregations. The specific subscriber system coordinates the use of the state arrest date being transmitted to the app. The app, upon receiving the arrest information, will mute the user's profile and notify and the subscribing organization.

Each member also can mute himself at will, for reasoning such as travel or other time constraints. A muted profile does not always mean an arrest or problem has taken place.

Some organizations may choose to have their users only interact with each other and others may allow their users to interact with the users from other subscribing organizations. This one organization or multi organizational use can be adjusted at any time by the subscribing organization.

Users can initiate a walk that is impromptu, that day or in advance. The request is submitted from the app and the interested user's profile pop up on the screen, along with a clickable cell number for each user. Coordination then happens via text or voice from user cell phones. Users can also initiate other plans, including travel by train, bus, cab or even coordination for flights.

### BRIEF DESCRITPION OF DRAWINGS

FIG. 1—FIG. 1 depicts a system diagram of a virtual connected process in which information is transferred from a data base of public arrest records to an app.

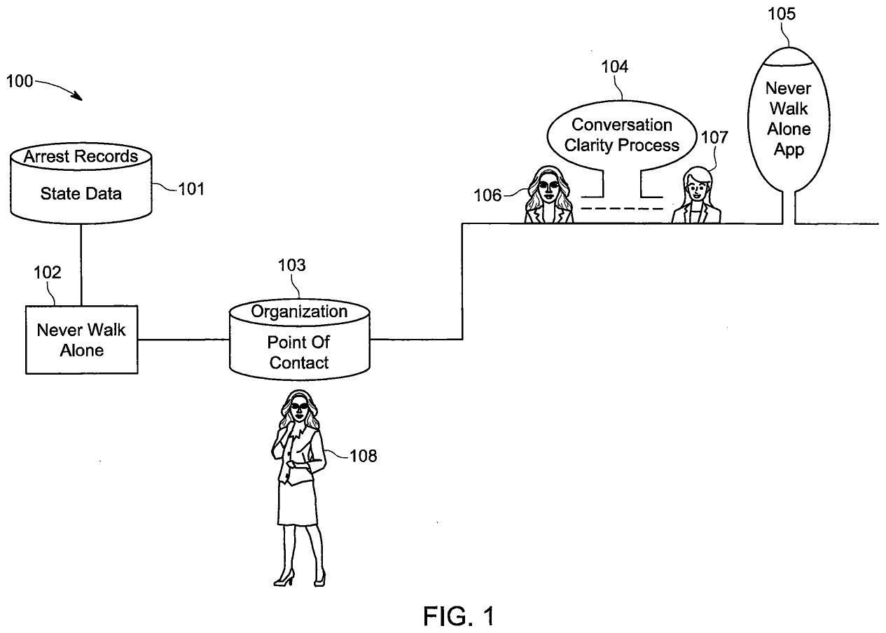

FIG. 2—Illustrates a communication link in which a user accesses and

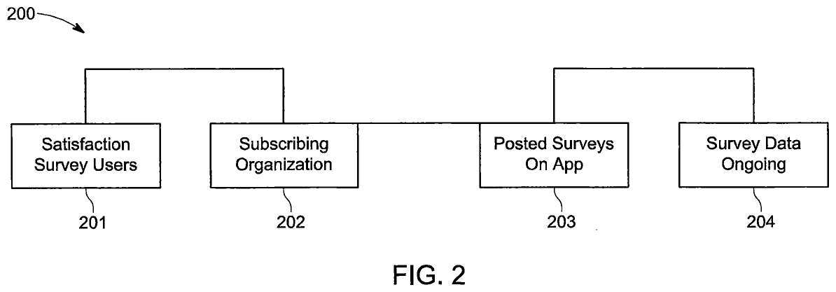

responds to an online survey on the app and links his response to his subscribing organization which then will connect the survey on the app's dedicated survey page.

FIG. 3—Shows a facilitation system and facilitation method for interfacing with various organizations to upload their profile and desired user's data to the app network for ongoing correspondence.

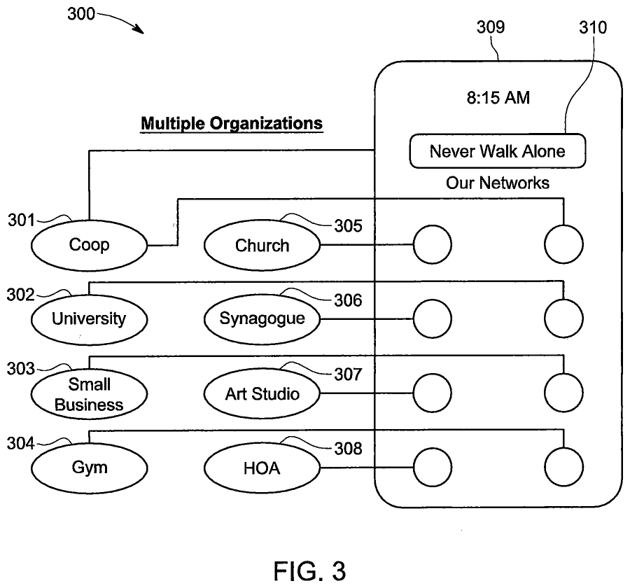

FIG. 4—Depicts the finite components of data transmitted from the new subscribing organization to the app and downloaded and installed by the app for interface between the organization and the app's existing subscribers.

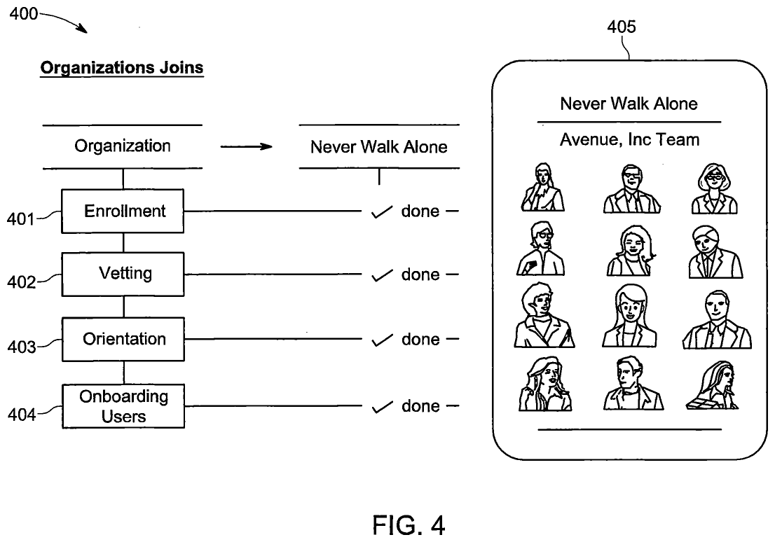

FIG. 5—Portrays the clarity of a muted profile whereas the user's once visible profile is temporarily muted through the interface between the subscribing organization and the app or the user himself and the app.

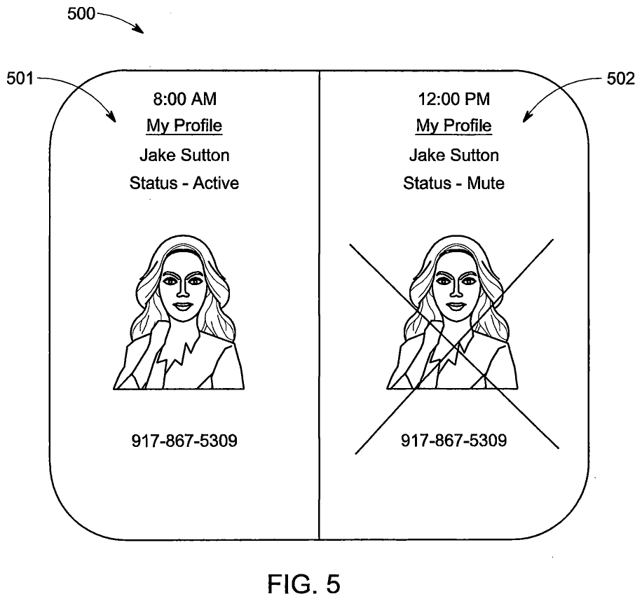

FIG. 6—Shows a data transfer system where arrest records from the state database cause the app profile to be muted of the user who was newly arrested. The subscribing organization is also in receipt of the data transfer.

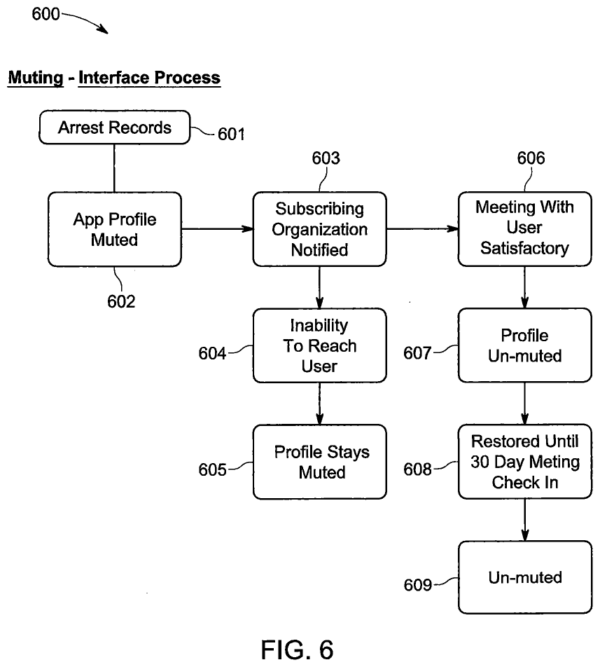

FIG. 7—Portrays users from the subscribing organizations interact with each other through the app or it can be decided for an organization to have targeted access for only its organization.

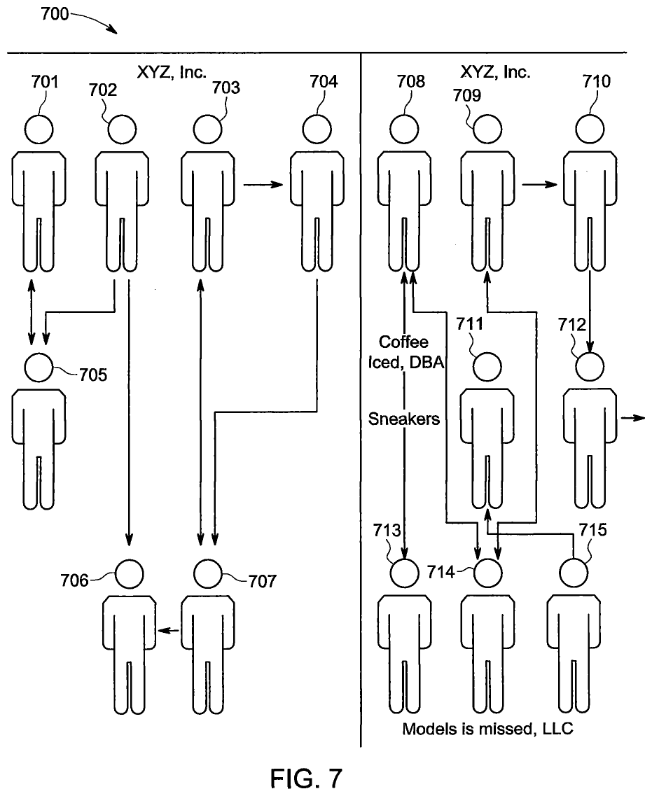

FIG. 8. Shows users can mute their profile at will without the involvement of the subscribing organization.

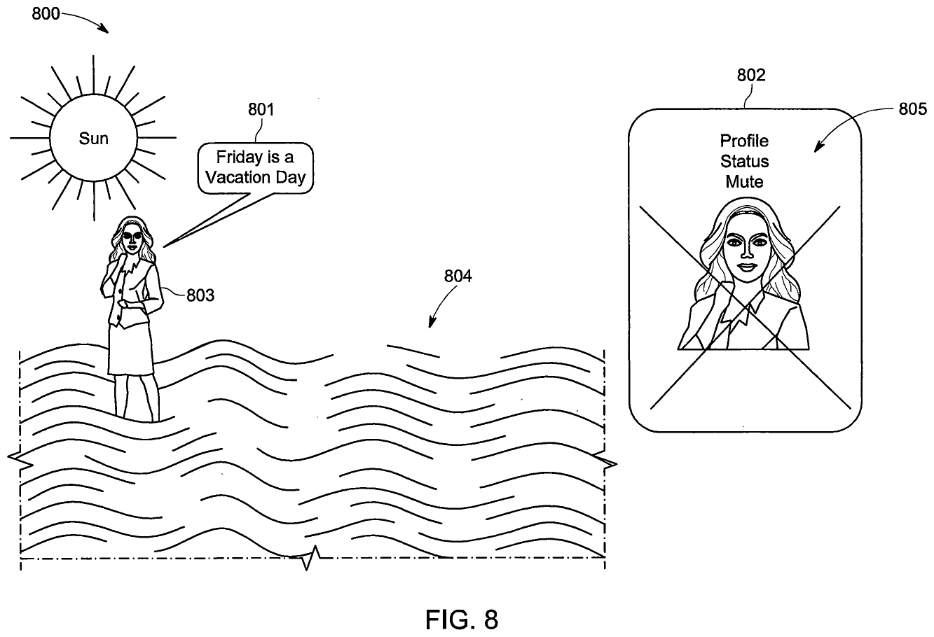

### DETAILED DESCRIPTION OF THE INVENTION

The present invention provides systems and methods for secured travel by connecting users within a defined group via a network to other pre-vetted users for accompaniment during walking or engaging in other types of transportation. The defined group may comprise organizations, corporations, schools, places of worship, gyms, housing complexes, or other types of groups. Users are connected to other user(s) within the predefined group for arranging traveling together. Users within a defined group can locate other users within a single defined group or a plurality of other defined groups in a targeted capacity, so that users may limit their interactions to other users within the same defined group.

The method includes the steps of receiving route information from a first registered user's mobile or stationary device over the network, the smartphone of the user subscribed as a member in the service, determining one or more second registered users to accompany the first register user from the group of registered users, and connecting the first and second registered users to enable joint travel.

For security purposes, administrators of each defined group can limit access of users in the group to only other selected users within that group.

The application also provides a muting feature that enables a user's profile to be made unavailable online. The user can delete his or her own profile at will and at any time. The muting feature also allows the subscribing organization to delete any user's profile within their organization. The muting allows a user to communicate his or her unavailability, the user has a recent arrest, or the user has exhibited behavior that his subscribing organization is interpreting as problematic. The present invention provides a substantially increased level of security for users to travel in public places. The system menu includes activities such as walking, ride sharing, commuting, errands, fitness, and travel.

Professional security can also be obtained in the same format for on foot or by car. Other items include notification of professional safety training, registration, and attendance confirmation. A subscribing organization can decide to use their own professional security company that is licensed or can opt to allow the Never Walk Alone app to provide a professional security company on the link.

Companionship for errands and appointments can also be coordinated on the app when a member shares the location, the event being scheduled and estimated time and circumstances involved.

What is claimed is:

1. An app comprising of user profiles where each user has access to a muting capability in which a user can mute his profile and cancel mute at any time.

2. An app that maintains data of its subscribing organizations and the users within each organization in order to, upon receipt of an arrest alert of a user from that organization, inform the subscribing organization of the arrest.

3. An app comprising of a menu where walking companionship can be requested and accepted by entering in location and destination, and accepting responses, as with a ride share.

4. An app that enables subscribing organizations to limit the users from its organization to communication through the app to only within their organization.

5. An app that enables subscribing organizations to set their users up for communication through the app with the users from the other subscribing organizations, in addition to their subscribing organization.
